(19) United States
(12) Patent Application Publication
(10) Pub. No.: US 2010/0145963 A1
(43) Pub. Date: Jun. 10, 2010

(54) Methods, Systems, And Computer Program Products For Resolving A Network Identifier Based On A Geospatial Domain Space Harmonized With A Non-Geospatial Domain Space

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/328,048

(22) Filed: Dec. 4, 2008

(51) Int. Cl. G06F 7/06; G06F 17/30; G06F 7/00

(52) U.S. Cl. 707/758; 707/E17.014

(57) ABSTRACT

Methods and systems are described for resolving a network identifier based on harmonized domain spaces. In one aspect, a query is received including a first harmonizing attribute and a first network identifier. The first network identifier includes a first domain portion identifying a domain in a first domain space and a geospatial domain region. The first harmonizing attribute identifies a network interface of a node in the domain in the first domain space. A second network identifier in a second domain space is retrieved that is associated with a geospatial node region at least partially included in the geospatial domain region. Evaluating a matching condition is provided for based on the harmonizing attributes. A query response is sent the second identifier identifying the network interface of the node identified by the first network identifier and the first harmonizing attribute.

### RELATED APPLICATIONS

This application is related to the following commonly owned U.S. patent applications, the entire disclosure of each being incorporated by reference herein:

application Ser. No. 11/962,285 (Attorney Docket No 1509/US) filed on Dec. 21, 2007, entitled “Methods And Systems For Sending Information To A Zone Included In An Internet Network”;

application Ser. No. 12/170,281 (Attorney Docket No 1522/US) filed on Jul. 10, 2008, entitled “Methods And Systems For Resolving A Geospatial Query Region To A Network Identifier”;

application Ser. No. 12/170,829 (Attorney Docket No 1523/US) filed on Jul. 10, 2008, entitled “Methods And Systems For Resolving Location Information To A Network Identifier”;

application Ser. No. 12/170,833 (Attorney Docket No 1524/US) filed on Jul. 10, 2008, entitled “Methods And Systems For Resolving A Query Region To A Network Identifier”;

application Ser. No. ______ (Attorney Docket No 1496/US) filed on ______, entitled “Methods, Systems, And Computer Program Products For Browsing Using A Geospatial Map Metaphor”;

application Ser. No. ______ (Attorney Docket No 1508/US) filed on ______, entitled “Methods, Systems, And Computer Program Products For Associating Resources Of A First Geospace With A Second Geospace”;

application Ser. No. ______ (Attorney Docket No 1516/US) filed on ______, entitled “Methods, Systems, And Computer Program Products For Accessing A Resource Based On Metadata Associated With A Location On A Map”;

application Ser. No. ______ (Attorney Docket No 1527/US) filed on ______, entitled “Methods, Systems, And Computer Program Products For Determining A Network Identifier Of A Node Providing A Type Of Service For A Geospatial Region”; and

application Ser. No. ______ (Attorney Docket No 1534/US) filed on ______, entitled “Methods, Systems, And Computer Program Products For Accessing A Resource Having A Network Address Associated With A Location On A Map.”

### BACKGROUND

Currently, the Internet Protocol (IP) address space may not use geospatial network addresses such as the format for IP version 6 network addresses based on a geospatial address portion and a node address portion recently proposed in a journal article entitled “Cartesian Routing” published in 2000. In the article, a geospatial routing system for routing using a geospatial portion of a network address was disclosed. The geospatial routing system would have to be a separate routing system from the current routing system. The current Domain Name System (DNS) can be used to associate names with network addresses that can be geospatial and non-geospatial. However, the process of resolving names using the current DNS system makes no use of geospatial information in a name.

Using a geospatial name to locate only multicast routers is a natural method for using a geospatial identifier because geospatial identifiers identify regions of space. Given that a region identified by a geospatial identifier can include more than one communication endpoint (e.g. a NIC) each with a different network address, there is no guarantee that a geospatial identifier identifies a single communication endpoint in the identified region. Thus, geospatial based names are associated with nodes that represent a region.

Directory systems exist that enable the mapping of a person's name to an address of one sort or another. Analogously, group names, commercial and non-commercial are indexed to a network address of one sort or another. In addition to lookup by entity name, lookup by street address is also supported, and lookup using one type of network address to determine another is also supported. For example, a phone number can be used to lookup an email address. None of these directory systems is suitable for network address lookup, in the sense that the DNS service is, because they are all susceptible to returning multiple results that are inconsistent. A DNS node name may be mapped to more than one IP address, but all the IP addresses represent nodes providing a common service and interface. These current directory systems are not suitable for integrating into the DNS system for the purpose of network address resolution.

### SUMMARY

A need therefore exists to resolve a non-geospatial network identifier to a geospatial network identifier and vice versa where a network identifier identifies a network interface of a node in a network.

Methods and systems are described for resolving a network identifier based on harmonized domain spaces. In one aspect, a query is received including a first harmonizing attribute and a first network identifier. The first network identifier includes a first domain portion identifying a domain in a first domain space and a geospatial domain region. The first harmonizing attribute identifies a network interface of a node in the domain in the first domain space. A second network identifier in a second domain space is retrieved that is associated with a geospatial node region at least partially included in the geospatial domain region. Evaluating a matching condition based on the second harmonizing attribute and the first harmonizing attribute matching is provided for. In response to determining a match based on the evaluation of the matching condition, a response to the query is sent including the second network identifier identifying the network interface of the node identified by the first network identifier and the first harmonizing attribute.

In another aspect, a query is received including a first harmonizing attribute and a first network identifier. The first network identifier includes a first domain portion identifying a domain in a first domain space. The first harmonizing attribute identifies a network interface of a node having a geospatial node region and in the domain in the first domain space. A second network identifier having a second harmonizing attribute is received. The second network identifier is in a domain in a second domain space having a geospatial region at least partially including the geospatial node region. Provided for is determining a matching condition based on the second harmonizing attribute and the first harmonizing attribute. In response to determining a match based on the evaluation of the matching condition, a response to the query is sent including the second network identifier identifying the network interface of the node identified by the first network identifier and the first harmonizing attribute.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a flow diagram illustrating a method for resolving a network identifier based on harmonized domain spaces according to an aspect of the subject matter described herein;

FIG. 2 is block a diagram illustrating components for resolving a network identifier based on harmonized domain spaces according to another aspect of the subject matter described herein;

FIG. 3 is a block diagram illustrating an exemplary execution environment in which the components of FIG. 2 are operable;

FIG. 4 is a block diagram illustrating a network having a node hosting an execution environment corresponding to the environment of FIG. 3 for hosting the components of FIG. 2 communicating with a network directory service according to an aspect of the subject matter described herein;

FIG. 5 is a flow diagram illustrating a method for resolving a network identifier based on harmonized domain spaces according to another aspect of the subject matter described herein;

FIG. 6 is block a diagram illustrating components for resolving a network identifier based on harmonized domain spaces according to another aspect of the subject matter described herein;

FIG. 7 is a block diagram illustrating an exemplary execution environment in which the components of FIG. 6 are operable; and

FIG. 8 is a block diagram illustrating a network having a node hosting an execution environment corresponding to the environment of FIG. 7 for hosting the components of FIG. 6 communicating with a geospatial network directory service according to an aspect of the subject matter described herein.

### DETAILED DESCRIPTION

A geospatial domain space can include one or more regions where each region is associated with one or more domains in the geospatial domain space. For the purposes of this specification, a region has a size that can be as large as the geospatial domain space in which it is included, or as small as can be identified. A location or region of a geospatial domain space can be associated with region information that uniquely identifies the region in the context of the geospatial domain space. Region information can include a geospatial identifier.

A geospatial identifier is an identifier including at least a portion that is usable for identifying a region/location in a geospatial domain space. Examples include:

postal://usa.nc.cary.corning-road:111.suite:220.placid

postal://placid.suite:220.corning_road:111.cary.nc.usa

postal://placid.suite:220:corning_road:111.27518.

Each of the above examples is a geospatial identifier in a geospatial domain space based on the US Post Office postal address domain space.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for addressing Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined to specify regions and locations having a variety of shapes such as a rectangle, circle, oval, or any shape including a closed region. A geospatial identifier can identify a region with disjoint sub-regions by including a geospatial attribute that identifies the sub-regions. For example, the identifier, “40+”, in an identifier domain space including average annual rainfall totals over a specified period, identifies a geospatial region including all sub-regions that have an average annual rainfall over 40 inches.

A geospatial identifier can include any of the forms and formats described above. Further a geospatial identifier can be a network identifier in the form of geospatial network address or in the form of a geospatial name corresponding to at least a portion of a network address.

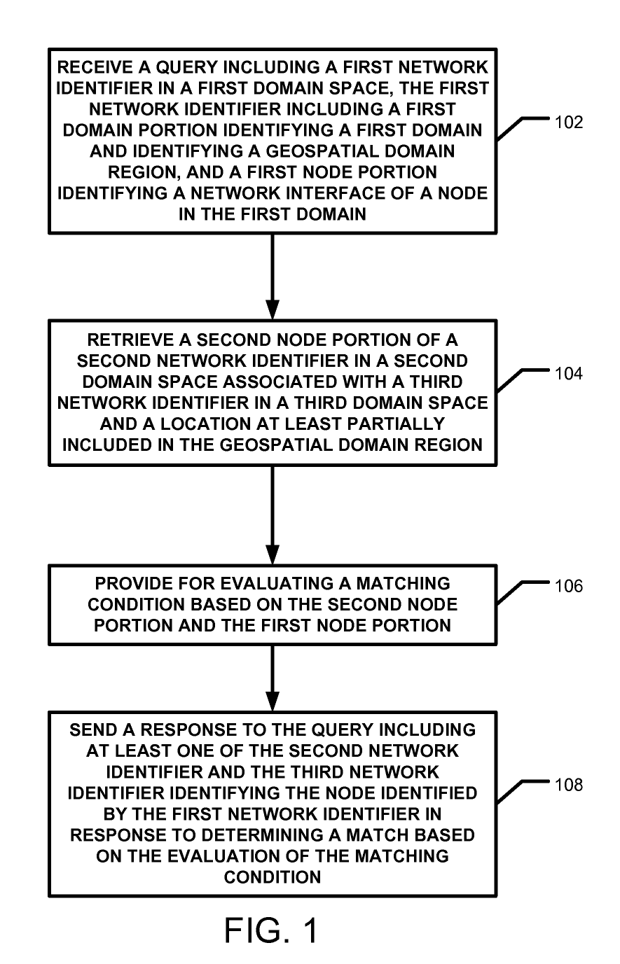

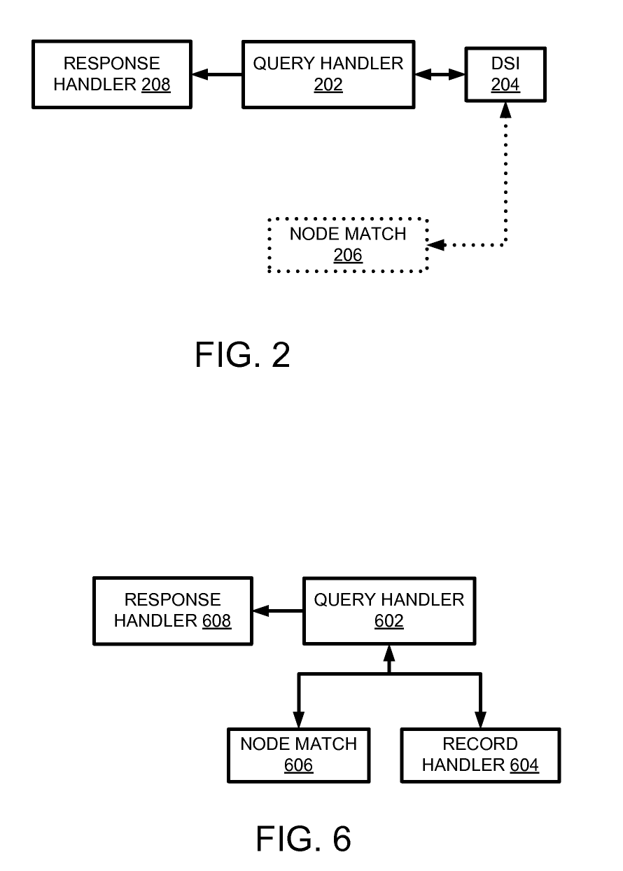

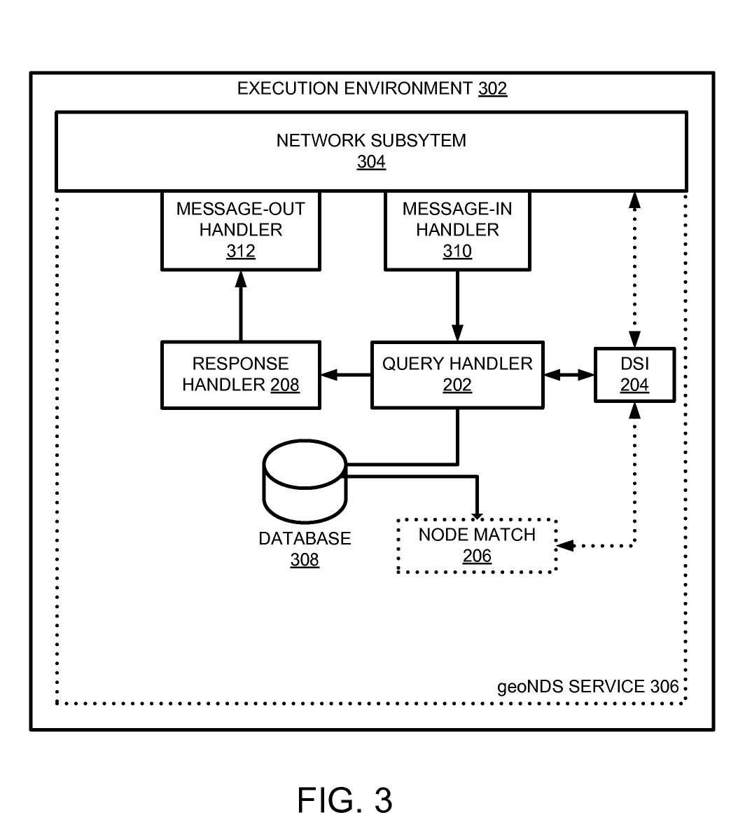

FIG. 1 is a flow diagram illustrating a method for resolving a network identifier based on harmonized domain spaces according to an exemplary aspect of the subject matter described herein. FIG. 2 is a block diagram illustrating an arrangement of components configured to resolve a network identifier based on harmonized domain spaces. More specifically, the components illustrated in FIG. 2 are configured to resolve an identifier in a geospatial domain space to a network identifier in another name space according to an exemplary embodiment of the subject matter described herein. FIG. 3 is a block diagram illustrating an arrangement of components providing an execution environment configured to host the arrangement of components in FIG. 2. The method illustrated in FIG. 1 can be carried out by, for example, some or all of the components illustrated in FIG. 2 operating in a compatible execution environment, such as the environment provided by some or all of the components illustrated in FIG. 3.

A network identifier is an identifier for a communication endpoint on a network. A network identifier includes at least one of a node portion identifying a node having a network interface in an identifiable portion of the network and a domain portion identifying the identifiable portion of the network. A network identifier can be a network address and/or a symbolic identifier of a network address, such as a name as known in the domain name system (DNS) domain space. A symbolic network identifier is a network identifier that is not usable as a network address on a particular network. A node is any device having a network interface operatively coupled to a network such as the Internet. A node can have, for example, an Ethernet network interface card (NIC) and/or a wireless adapter configured to provide a network interface. The term “network identifier” is used interchangeably with the terms network address and network name or symbolic identifier in this specification.

For example a network address, such as an IP address, includes a domain portion referred to as a subnet ID. For example, the partial IP address, 162.195.20, identifies a subnet including one or more nodes with network addresses that begin with the IP address prefix 169.185.20. To more precisely identify a subnet an IP address or a portion of an IP address can be associated with a mask, such as 255.255.255.0. The mask identifies a subnet portion of an IP address via a logical “or” operation performed between each pair of bits identified by bit position in an IP address and the mask.

Analogously, a symbolic identifier identifying a node, such as a DNS name, includes a portion identifying a domain and optionally subdomains each identifying a portion of a network, such as the Internet. For example, “nc.sceneralabs.com”, can identify a naming domain where a network interface of a node in the naming domain is associated with a node name such as, “placid”. “placid” identifies the node having a network interface in the naming domain. The terms network interface and node interface are used interchangeably in this specification. The complete network name, “placid.nc.sceneralabs.com”, identifies the node in the context of the network.

A network identifier includes a node portion that identifies a node having a network interface in the portion of the network identified by the domain portion of the network identifier. For example, in an IP address a portion of the address is associated with a particular network interface in the identified subnet. In the IP address 162.195.20.143 in a subnet 162.195.20.0/255.255.255.0, 143 is a node portion identifying a network interface and its node in the subnet identified by 162.195.20. A subnet is a domain in the network address domain space. In another example, in a DNS name the first portion of the name identifies a node having a network interface in the identified naming domain. As indicated, ‘placid”, is a node portion in a naming domain identified by “nc.sceneralabs.com”, and “placid.nc” is a node portion in a parent naming domain identified by a domain portion, “sceneralabs.com.”

Note that a subnet is a domain in a network address domain space. A subnet and a domain in a naming domain, such as the DNS naming domain space, can have a one to one correspondence, but a one to one correspondence is not required. For example, a domain in a naming domain space can be associated with one or more subnets. Further, a subnet can include nodes with network interfaces included in a single domain of a naming domain space and/or can include nodes with network interfaces included in more than one domain in a naming domain space. The cardinality of the relationships between domains of two domain spaces is specific to the two domain spaces. The discussion above illustrating a many-to-many relationship between subnets in a network address domain space and naming domains in a name domain space is exemplary and is applicable to an IP based network address space associated with a DNS naming domain space.

A domain space is said to include one or more nodes having network identifiers from the domain space or in the domain space. In the context of this specification both a network identifier from the domain space and a node having a network identifier from the domain space are said to be “in” and “included in” the domain space. Analogously both a network identifier from a domain of the domain space and a node having the network identifier from the domain are said to be “in” and “included in” the domain. A domain in a domain space can have a geospatial region associated with the domain, referred to herein as a domain region. A domain region can be included in a real-world space or a geospatial virtual space. A region can be represented in a map and/or can be considered a region of a map. The association between a domain and a domain region can be based on a relationship between the domain region and the domain and/or a node having a network identifier in the domain. The relationship can be of any type, be unidirectional or bidirectional, and can have cardinality. For example, the relationship associating a domain with a domain region can be of a type based on at least one of an owner, a user, an administrator, a purchase of, a legal right associated with, an authentication service for, an authorization service for, a signer of a digital certificate for one or more of the domain, a node in the domain, and the domain region.

With reference to FIG. 1, in block 102 a query is received including a first harmonizing attribute and a first network identifier. The first network identifier has a first domain portion identifying a domain in a first domain space and identifying a geospatial domain region. The first harmonizing attribute identifies a network interface of a node in the domain in the first domain space. Accordingly, a system for resolving a network identifier based on harmonized domain spaces includes means for receiving a query including a first harmonizing attribute and a first network identifier having a first domain portion identifying a domain in a first domain space and identifying a geospatial domain region, the first harmonizing attribute identifying a network interface of the node in the domain in the first domain space. For example, as illustrated in FIG. 2, a query handler component 202 is configured to receive a query including a first harmonizing attribute and a first network identifier having a first domain portion identifying a domain in a first domain space and identifying a geospatial domain region, the first harmonizing attribute identifying a network interface of the node in the domain in the first domain space. The first harmonizing attribute can be a requesting node portion identifying the node in the first domain identified by the first identifier. The query can be formatted according to a publish-subscribe protocol, a presence protocol, a request-reply protocol, a store-and-forward protocol, and a DNS protocol.

The query received by the query handler component 202 includes a first network identifier in a domain in a first domain space. Network identifiers in a domain space have a domain portion as described above. A domain portion identifies a domain in the domain space. Additionally the domain portion identifies a geospatial region, referred to as a geospatial domain region or domain region in this specification. The identification can be direct and/or indirect through a relationship or association. The identification can further be explicit and/or implicit as described below with respect to scoped addresses. In this specification, a domain space where domain identifiers identify a domain region is called a geospatial domain space and each domain is called a geospatial domain. Examples of geospatial identifiers in the form of names and in the form of network addresses are described above. A geospatial identifier can be a network identifier such as a network name of a portion of a network and/or a network interface of node, or a network address of a subnet and/or a network interface of a node.

The query handler component 202 and other components illustrated in FIG. 2 can be adapted to operate in a number of execution environments, such as an execution environment 302 illustrated in FIG. 3. An exemplary execution environment can include a memory for storing instructions and data of the components illustrated in FIG. 2 or their analogs, a processor for processing the instructions and implementing components, a control program or operating system for managing the memory and processor making the instructions and data of components such as the components illustrated in FIG. 2 accessible to the processor. The execution environment 302 includes any other subsystems required by a particular configuration of the components illustrated in FIG. 2 or their analogs. Such subsystems are common to computing devices such as desktop computers, servers, laptop computers, handheld computing devices, etc. For example, the execution environment 302 includes a network subsystem 304 configured to provide network communications in interoperation with at least some of the components operating in the execution environment 302. Execution environments can be provided by a node or a distributed execution environment can be provide by a collection of nodes.

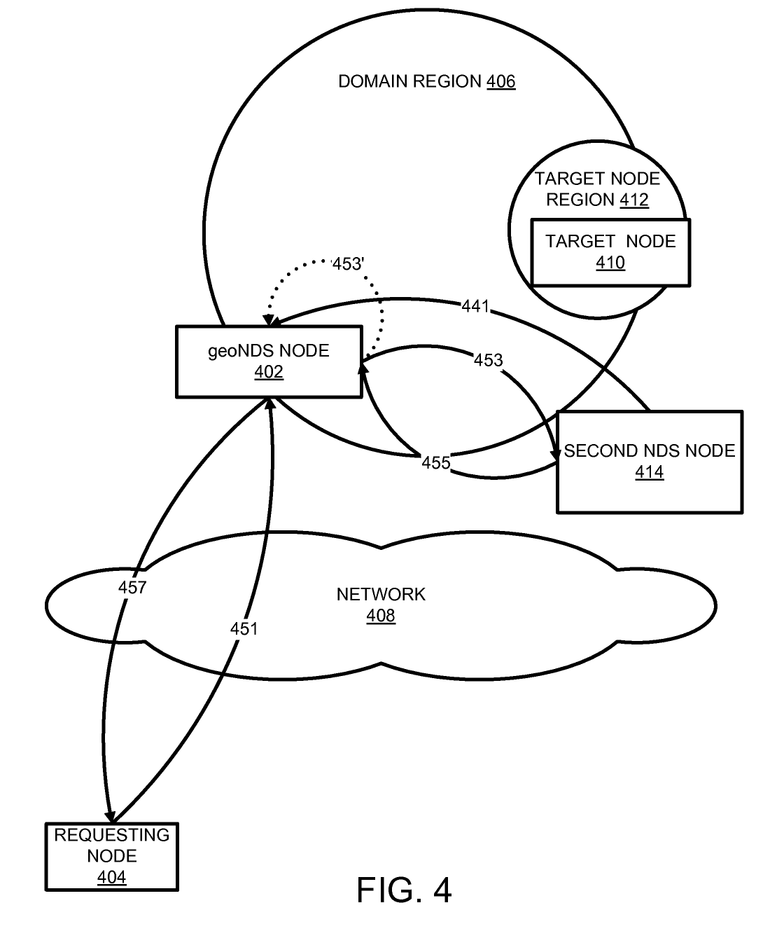

FIG. 4 illustrates a geospatial network directory system (geoNDS) node 402 providing the execution environment 302 hosting the query handler component 202 included in a geoNDS service 306. A geoNDS service represents a geospatial domain in a first domain space. A geospatial domain identifies a geospatial region as described above. Those skilled in the art will recognize the domain name system (DNS) and LDAP directory systems as exemplary network directory system (NDS). A NDS that provides a directory for a geospatial domain space is referred to as a geospatial network directory service (geoNDS) and nodes in a geoNDS are referred to as geoNDS nodes in this specification.

A geoNDS service 306 can be configured to maintain one or more associations between a node having network interface identified by a network identifier from a geospatial domain represented by the service and a network identifier of the network interface of the node from a different domain space. A geoNDS service thus maintains an association between the network identifier from the different domain space and the domain region of the represented geospatial domain. A geoNDS can be configured to maintain an association between the represented geospatial domain and a network identifier from a different domain space of a network interface of a node having a node region that is at least partially included in the domain region. Note that the node region can be the domain region. Further a geoNDS can be configured to maintain an association between at least one of a network identifier from the represented geospatial domain and the second domain from the second domain space and a network identifier from the represented geospatial domain and an identified domain from a third domain space that can be geospatial or non-geospatial. Associations can be stored in a memory, such as a database component 308 as illustrated in FIG. 3.

The components of FIG. 2 are illustrated in FIG. 3 adapted for operation in the execution environment 302. The execution environment 302 can be provided by the geoNDS node 402 as described above. A requesting node 404 can be configured to send a query message 451 including a first network identifier in the form of a network address and/or in the form of a symbolic identifier of a network interface of a node in a first domain space. For example, the received network identifier can be “usa.nc.cary.road-corning:111.suite:220.placid” in a domain space defined to include postal street addresses, “placid.nc.sceneralabs.com” from a traditional DNS name space, or a network address such as an IP network address. FIG. 4 illustrates the query message 451 can be received by the geoNDS node 402 hosting the geoNDS service 306 representing a domain in the first domain space. The represented domain in the first domain space has a domain region as illustrated by a domain region 406 in FIG. 4.

As described above and below a network identifier explicitly and/or implicitly has and/or includes a domain portion identifying a domain and a node portion identifying a node having a network interface in the identified domain. The node portion can be a harmonizing attribute as described in examplary alternatives below. The exemplary network identifier, “usa.nc.cary.road-corning:111.suite:220.placid”, includes several (domain portion, node portion) pairs. The pairs include (usa, nc.cary.road-corning:111.suite220.placid), (usa.nc.cary, road-corning:111.suite220.placid), and (usa.nc.cary.road-corning:111.suite220, placid). The first element in each pair is a domain portion for the pair identifying a network domain and identifying a domain region. The second element of each pair is a node portion identifying a node having a network interface in the identified domain.

A query message 451 can include a harmonizing attribute in addition and/or instead of a node portion of the network identifier in the query message 451. A harmonizing attribute can be any data associated with a network identifier for matching another network identifier, in a domain in a second domain space, having a second harmonizing attribute. Harmonizing attributes are included in evaluating a matching condition. When a matching condition is evaluated and a match is determined, the first and second network identifiers are resolved to one another. Examplery harmonizing attributes include service type, port number, application ID, owner identifier, serial number, and the like. A node portion of a network identifier can be a harmonizing attribute in an aspect.

In various alternatives, multiple harmonizing attributes can be included in a query message and a matching condition can be evaluated based on one or more harmonizing attributes included in the query message. For example, a node portion of a network identifier and an application identifier can be included in a query message. Alternatively, a query message can be sent including a domain portion of a network identifier and a harmonizing attribute, such as service identifier, where the messsage does not explicitly include a node portion of the network identifier.

A scoped identifier can be included in a query message and received by the query handler component 202 and processed according to the method illustrated in FIG. 1 by some or all of the components illustrated in FIG. 2 operating in a compatible execution environment. For example, the identifier, “cary.road-corning:111.suite220.placid”, can be a scoped identifier where the scope is a state in the United States or some other scope that includes cities such as a county, parish, and/or territory. A scoped identifier can include a domain portion identifying a domain within a particular scope. For example, within the scope of the state of North Carolina, “cary” identifies a subdomain within the domain of North Carolina. “cary” can be a domain portion of the exemplary identifier with “road-corning:111.suite:220.placid” as the node portion. The scoped identifier “placid” includes an implicit domain portion. The implicit domain is the domain within which the scoped identifier “placid” is used.

A domain region is illustrated in FIG. 4 as a domain region 406 identified by a domain portion of a network identifier. The geoNDS node 402 represents the domain, in the first domain space, identified by the domain portion of the received network identifier. The domain portion also identifies the domain region 406.

The query message 451 can be received by the query handler component 202 via a message-in handler component 310. The message handler component 310 can be configured to interoperate with the network subsystem 304 to listen for messages addressed to the geoNDS service 306 operating in the execution environment 302 in the geoNDS node 402. The network subsystem 304 can include a network stack, such as a TCP/IP network stack, including a network interface card (NIC), such as an Ethernet adapter, communicatively coupled to a network 408. The query message 451 can be sent by the requesting node 404 via the network 408 to the geoNDS node 402 where it is received by the query handler component 202 as described.

The requesting node 404 can host an application including an identifier of a node such as a target node 410. The identifier can be a symbolic identifier. The application can be configured to establish communication via the network 408 with the target node 410. The requesting node 404 can be configured to determine a network address of a network interface of the target node 410 based on the included symbolic identifier of the target node 410. The symbolic identifier included in the application can be a DNS name, a name from a geospatial domain space, a network address from a geospatial address domain space, or network address from a non-geospatial network address domain space.

In an example, the identifier is not usable as a network address for the network 408 and thus is a symbolic identifier to be resolved to a usable network address for communicating with the target node 410 via the network 408. The query message 451 can include, for example, a symbolic name of the target node 410 for determining a network address of the target node 410 on the network 408. The name of the target node 410 can be in a geospatial name space and/or be associated with a geospatial identifier in a geospatial name space. The name of the target node 410 has a domain portion identifying the domain region 406 either directly by being in the geospatial domain of the domain region 406 or indirectly by being included in an association with the geospatial domain of the domain region 406 and by a scope of the name. The name is in a first domain space including the domain identified by the domain portion of the name and identifying the domain region 406 directly and/or indirectly. The domain in the first domain space can be represented by the geoNDS service 306 operating in the geoNDS node 402. The queried network address, the second network identifier, is in a domain in a second domain space. For example, the second domain space can include network addresses, such as network addresses in the IP address space and the domain can identify a subnet. One or both of the first network identifier in the query message 451 and the queried second network identifier of the target node 410 can be a geospatial identifier, and/or can be associated with a geospatial identifier.

Alternatively and analogously, the application in the requesting node 404 can have a first network identifier and be configured to lookup a second network identifier from a second domain space of symbolic network identifiers.

The message-in handler component 310 can be configured to route a received message based on an attribute of the message such as a message format and/or a command or other value included in the received message. The query handler component 202 in FIG. 3 can receive the query message information based on the received query message 451 from the message-in handler component 310 configured to route the query message information to the query handler component 202.

Returning to FIG. 1, in block 104 a second network identifier having a second harmonizing attribute is received/retrieved. The second network identifier is in a domain in a second domain space associated with a geospatial node region at least partially included in the geospatial domain region. Accordingly, a system for resolving a network identifier based on harmonized domain spaces includes means for receiving a second network identifier having a second harmonizing attribute, the second network identifier in a domain in a second domain space and associated with a geospatial node region at least partially included in the geospatial domain region. For example, as illustrated in FIG. 2, a domain space interface (DSI) component 204 can be configured to receive a second network identifier having a second harmonizing attribute, the second network identifier in a domain in a second domain space and associated with a geospatial node region at least partially included in the geospatial domain region. The second harmonizing attribute can be a node portion of the second network identifier.

The geoNDS service 306 can be configured to provide a service for resolving network identifiers in a domain in a first domain space to network identifiers in a second domain space. One or both of the domain spaces is a geospatial domain space. The current DNS maintains a database for resolving a name from the DNS name domain space to a network address in the IP address space and vice versa. Neither of these domain spaces includes any geospatial domains represented by a DNS node. The DNS provides a LOC record for mapping an IP address from the IP address space to a geospatial identifier such as a GPS coordinate or a street address. The DNS does not provide the ability to map a geospatial identifier to any network identifier from any domain space. The current DNS provides no mechanism for identifying a DNS service that represents a geospatial domain. In fact, geospatial domains are not represented by the current DNS. The geospatial information, as referred to herein as a geospatial identifier, in a LOC record is not constrained to any particular geospatial domain space making the task of resolving a geospatial identifier in a geospatial domain space to a network identifier in another domain space even more difficult.

A specified geospatial region can have more than one node with a network interface associated with the identifier of the region. The terms “region” and “location” are used interchangeably in this specification. A node portion identifying a network interface associated with a domain region can be associated with a geospatial identifier of the region and/or can be associated with an identifier of a location at least partially present in the region. This is still not enough to guarantee that the geospatial identifier uniquely identifies a network interface of a node associated with the geospatial region since multiple nodes can be associated with a region.

A node can be identified uniquely based on a geospatial identifier from a geospatial domain space. For example, network identifiers can be assigned within the context of each identifiable domain that is unique within each domain. Each domain can be uniquely identified within the domain space and represented by one or more geoNDS services in a geoNDS representing the geospatial domain space. A geoNDS service representing a domain in a first domain space can be configured to maintain associations between a geospatial identifier and a network identifier in a domain in a second domain space. A geospatial identifier in an association maintained by a geoNDS service can identify a domain region of the geospatial domain represented by the geoNDS service, identify a location at least partially present in the domain region, and/or be included in a network identifier in the geospatial domain represented by the geoNDS service identifying a network interface of node in the represented geospatial domain in a geospatial domain space. The network identifier in the second domain can identify a network interface of a node in a domain in a second domain space and/or can identify a domain in the second domain space. The associations can be maintained in one or more records making a direct association between a geospatial network identifier and a network identifier in a second domain space. Alternatively or additionally, the associations can be formed indirectly by linking multiple network identifiers and/or identifiers of geospatial regions including the domain region and/or one or more domain/node regions in order to resolve the first network identifier in a first domain space to a second network identifier in a second domain space. A node can have a node region associated with the node through a network identifier of the node as is the case with a DNS LOC record provided to maintain an association between an IP address and a geospatial identifier.

For example, a network interface of a node in a network can be assigned an IP address from the IP network address domain space, such as 243.15.5.152. The network interface of the node can also be given a name from the current domain space, such as placid.nc.sceneralabs.com. A location update message can be sent to a DNS server including a geospatial identifier for creating or updating a LOC record for the network interface of the node. The exemplary DNS server represents the domain, nc.sceneralabs.com, in the DNS name domain space. In representing the domain, nc.sceneralabs.com, the DNS server maintains a database including a record mapping the name, placid, to the assigned IP address, 243.15.5.152. Based on receiving and processing the location update message, the DNS server maintains a LOC record mapping the IP address, 243.15.5.152, to a geospatial identifier based on the geospatial identifier in the update location message. For example, the update location message can include the US postal address, 111 Corning Road, Suite 220, Cary, N.C. 27581. The DNS can generate the geospatial identifier usa.nc.cary.road-corning:111.suite:220, as a geospatial identifier. The DNS can create or update a record associating the IP address, 243.15.5.152, with the generated geospatial identifier, usa.nc.cary.road-corning:111.suite:220.

The DNS service for the naming domain can generate a geospatial domain identifier for a network interface of a node, such as the target node 410, identified by a network identifier, such as an IP network address and/or DNS name, based on a geospatial identifier in a LOC record identifying the network interface of the target node 410 and a node region 412. The DNS service, such a NDS service hosted by a second NDS node 414, can send an update message, such as a message 441 illustrated in FIG. 4, to register or update a registration with an NDS server such as the geoNDS service 306 in the geoNDS node 402, configured to represent a domain having a domain region, such as the domain region 406, that at least partially includes the node region 412. The domain having the domain region 406 is in a first domain space. The DNS service representing the domain in the second domain space (e.g. DNS name space and/or IP address space) can send an update message 441 with registration information identifying the domain in the second domain space along with the geospatial identifier. The registration information can include additional information such as one or more harmonizing attributes, such as the node portion from the network name and/or the IP network address, as described in various alternatives below. The update message 441 can be routed to a geoNDS service that represents the domain, in the first domain space, identifying the domain region 406 that at least partially includes the node region 412 identified by the geospatial identifier in the update message 441, such as the geoNDS service 306 operating in the geoNDS node 402. Note the current DNS system can be modified as described herein to be a geoNDS.

The registration information can be received by the geoDNS node 402 hosting the geoDNS service 306 representing the domain region 406 identified by the registration information. The geoNDS service 306 can be configured to update or create a record allowing the geoNDS service 306 to communicate with and/or otherwise identify the second NDS node 414 that originated the message 441 including the registration information and represents the DNS domain of the network interface of the target node 414 in the domain in the second domain space.

Exemplary associations are described below. These examples are intended to be illustrative and are not exhaustive. The geoNDS service 306 can maintain records associating a geospatial identifier of the domain region 406 and/or a location at least partially present in the domain region 406 with an identifier of the second domain, the second network identifier in the second domain, and/or a harmonizing attribute that can be included in or otherwise provided with the second network identifier, and/or any information that enables the geoDNS service 306 to identify a DNS service representing an NDS node representing a domain in a second domain space. The second domain space can include symbolic network identifiers of network interfaces and/or naming domains; and/or can include network addresses identifying network domains/subnets and network addresses of network interfaces of nodes.

For network interfaces of nodes that are not mobile, the DNS service that represents the name domain, the IP address domain, and/or the geospatial domain, it can be beneficial to configure the same NDS node to host a DNS service configured to represent each of the domains in the domain spaces. For network interfaces of nodes where one or more of the naming domain, subnet, or the geospatial domain changes, multiple NDS nodes can be a better choice in many cases for maintaining associations among network identifiers and geospatial identifiers from the various domain spaces including a node with a network interface identified in each of the various domain spaces. Those skilled in the art will understand that there a numerous records for maintaining associations across multiple domain spaces. The DNS system represents one alternative. Within the DNS those skilled in the art will appreciate that there are a variety of data storage formats and schemas for storing geospatial network identifiers and records for maintaining an association between a geospatial identifier and an identifier in another domain space.

Regardless of the number of NDS services maintaining associations among the network and/or geospatial identifiers maintained for the domain spaces and regardless of the storage formats and schemas used, the geoNDS service 306 receiving the query message 451 can be configured to identify a domain in a second domain space that includes the second network identifier of the network interface of the node identified by the received network identifier and harmonizing attribute. The DSI component 204 illustrated in FIG. 2 is configured to receive a second network identifier having a second harmonizing attribute, such as a node portion of a second network identifier in a second domain. For example, a node portion “placid” in the DNS domain name space or “152” the IP network address domain space can be second harmonizing attributes of received network identifiers “placid.111-Corning-Road.Suite:220.Cary.NC.27518” and “243.15.5.152”, respectively.

A match message 453 can be generated by the DSI component 204 or other component interoperating with the DSI component 204 in the geoNDS service 306 based on the query message 451. For example, the match message 453 can include a harmonizing attribute received in the query message 451, such as a node portion of a first network identifier. Alternatively or additionally, the generated match message 453 can include the domain portion of the first network identifier identified in the query message 451. Alternatively or additionally, the match message 453 can include a geospatial identifier included in the first network identifier and/or associated with the first network identifier, such as an identifier of the domain region 406. Alternatively, no information from the query message 451 can be included in the match message 453. The geoNDS service 306 can be configured to include information in the match message 453 according to a particular configuration for distributing the performing of the evaluation of a matching condition for generating a response to the query message 451. A matching condition can include one or more matching conditions that can be evaluated in one or more evaluation operations. In an alternative, the geoNDS 306 can provide information allowing all the matching to be performed external to the geoNDS service 306. In another alternative, the geoNDS service 306 can provide information allowing all the matching to be performed by the geoNDS service 306. Various other alternatives include information in a matching message 453 to distribute the evaluation operation(s to various components within the geoNDS service 306 and external to the geoNDS service 306 operating in the geoNDS node 402 and/or in other nodes.

The match message 453 can be sent to an NDS service representing a domain in the second domain space, illustrated as the second NDS node 414, identified by an association based on the first network identifier received in the query message 451. The match message 453 can be sent to a component within the execution environment 302 including a component of the geoNDS service 306 representing the domain in the second domain space (illustrated by the dotted line message 453′). Alternatively, the DSI component 204 can send or provide for sending the match message 453 to the second NDS node 414 representing a domain in the second domain.

The geoNDS service 306 can maintain an association between the represented domain and an identifier of the domain in the second domain space indicating that a second network identifier in the domain in the second domain space has a node region at least partially included in the domain region 406 represented by the geoNDS service 306. The association can be maintained in a database component 308. If more than one domain in a second domain space is identified in maintained associations, a match messages can be sent to NDS nodes each representing one or more of the domains in the second domain space(s). A receiving second NDS node 414 can determine one or more network interfaces of nodes having network identifiers in the domain in the second domain space that have node regions that are at least partially included in the domain region 406. The determined one or more network identifiers along with corresponding harmonizing attributes for each one or more determined network interfaces can be included in a match response message 455 generated and sent by the second NDS node 414 via the network 408. The match response message 455 can be received by the DSI component 204 via the network subsystem 304.

In another alternative, a geoNDS service 306 can maintain an association between the represented domain and a node region, at least partially included in the domain region of the represented domain. The node having the node region can be identified by a network identifier in the domain in a second domain space. The association can be maintained in the database component 308. The DSI component 204 can be configured to generate and send a match message 453 via the network subsystem 304 and the network 408 to a second NDS node 414 representing a domain in the second domain space. A match message 453 can identify a node region of a network interface of a node in an association maintained in the second NDS node 414 eliminating a corresponding portion of the matching operation as opposed to the alternative described in the previous paragraph. The second NDS node 414 and/or other NDS nodes representing domains in a second domain space can determine one or more network identifiers of network interfaces of nodes, such as the target node 410, in the domain in the second domain space having a matching node region, such as the node region 412 illustrated in FIG. 4. The NDS service in the second NDS node 414 can be configured to determine exact matches between node regions or matches that meet some other matching condition, such as determining an overlap between the received node region and a node region of a node having a network identifier in the domain in the second domain space. The determined one or more network identifiers along with corresponding harmonizing attributes for each of the one or more determined network identifiers can be included in a match response message 455 generated and sent by the second NDS node 414 via the network 408. The match response message 455 can be received by the DSI component 204 via the network subsystem 304.

In another alternative, the geoNDS service 306 can maintain an association between the represented domain and a second harmonizing attribute of a network interface of a node having a network identifier in the domain in the second domain space and having a node region at least partially included in the domain region 406. The DSI component 204 can invoke an optional node match component 206 illustrated in FIG. 2 and illustrated as adapted to operate in the execution environment 302 in FIG. 3. The node match component 206 can be configured to evaluate a matching condition based on the first harmonizing attribute and the second harmonizing attribute. If the condition is met, the DSI component 204 can be configured to generate and send a match message 453 to a second NDS node 414 representing a domain in a second domain space. The match message 453 can identify the second harmonizing attribute and the domain region 406 to the second NDS node 414. The second NDS node 414 can determine one or more network identifiers having a matching harmonizing attribute and a node region at least partially included in the domain region, as described in detail below. The determined one or more network identifiers along with any unevaluated corresponding harmonizing attributes for each one or more determined network identifiers can be included in a match response message 455 generated and sent by the second NDS node 414 via the network 408. The match response message 455 can be received by the DSI component 204 via the network subsystem 304.

In yet another alternative, the geoNDS service 306 can maintain an association between the represented domain, a harmonizing attribute, and a node region, at least partially included in the domain region, of a node having a network identifier in the domain in the second domain space. A node match component 206 invoked by the DSI component 204 can be configured to evaluate a matching condition based on the first harmonizing attribute and the second harmonizing attribute. The node match component 206 can be configured to determine NDS nodes representing a domain in a second domain space corresponding to a second harmonizing attribute producing a match in an evaluation of the matching condition based on the first and second harmonizing attributes. In response, the DSI component 204 can generate and send a match message 453 to the corresponding second NDS node 414. The match message 453 can identify the second harmonizing attribute and the node region to the second NDS node 414. The second NDS node 414 can determine one or more network identifiers having a matching harmonizing attribute and a node region matching the received node region based on a matching condition. The determined one or more network identifiers along with any unevaluated corresponding harmonizing attributes for each one or more determined network identifiers can be included in a match response message 455 generated and sent by the second NDS node 414 via the network 408. The match response message 455 can be received by the DSI component 204 via the network subsystem 304.

The geoNDS service 306, in a further alternative, can maintain an association between the represented domain and a network identifier from a domain in the second domain space, harmonizing attribute, and a node region at least partially included in the domain region of a network interface of a node having a network identifier in the domain in the second domain space. A node match component 206 invoked by the DSI component 204 can be configured to evaluate a matching condition based on the first harmonizing attribute and the second harmonizing attribute to resolve the first network identifier to a second network identifier in a domain in a second domain space. A message 453 can include a call, an interprocess communication, and/or a sequence of executable machine code instructions (i.e. the message 453 can be implicit) from the DSI component 204 to the node match component 206 to perform the evaluation. The determined one or more nodes along with and unevaluated corresponding harmonizing attributes for each one or more determined network identifiers can be included in a match response message 455 generated and sent by the second NDS node 414 via the network 408. The match response message 455 can be received by the DSI component 204 via the network subsystem 304.

The geoNDS service 306 can maintain an association between the received first identifier and a network identifier in the domain in the second domain space. The association can be established based on previously matching a first harmonizing attribute and a second harmonizing attribute, and determining that the network identified by the second network identifier has a node region at least partially included in the domain region 406.

The various alternatives described above are not intended to be exhaustive as those skilled in the art will understand.

As described above, the second NDS node 414 representing the domain in the second domain space can be configured to locate one or more network identifiers based on the information included in the match message. If no information is sent, the second NDS node 414 can identify all network identifiers in the domain in the second domain space. If a node region is sent, the second NDS node can identify one or more network identifiers in the domain in the second domain space that have matching node regions. If all relevant first harmonizing attributes are included in the match message 453 and the domain region 406, subregion in the domain region 406, and/or location at least partially included in the domain region are also identified in the match message 453, the second NDS node 414 can resolve the first network identifier to a second network identifier in the domain in the second domain space based on an evaluation of a matching condition including the first and second harmonizing attributes for a second network identifier of a network interface of a node having a node region at least partially included in the domain region 406 as determined based on the location information included in the match message 453.

For example, the node portion of the received first network identifier can be a name such as placid. A DNS service representing a naming domain, nc.sceneralabs.com, can include an association between the node portion “placid” and the IP address 243.15.5.152 as maintained in DNS A records currently. The DNS service can locate the A record including the matching node portion “placid” and respond to the match message 453 by returning a match response message 455 including the network name, placid.nc.sceneralab.com to the DSI component 204 and or by including the name “placid.nc.sceneralabs.com” depending on the match message information and the configuration of the receiving second NDS node 414.

Returning to FIG. 1, in block 106 evaluating a matching condition is provided for. The matching condition is based on the second harmonizing attribute and the first harmonizing attribute. Accordingly, a system for resolving a network identifier based on harmonized domain spaces includes means for providing for evaluating a matching condition based on the second harmonizing attribute and the first harmonizing attribute. For example, as illustrated in FIG. 2, the domain space interface component (DSI) component 204 is configured to provide for evaluating a matching condition based on the second harmonizing attribute and the first harmonizing attribute. The second harmonizing attribute can be the node portion of the second network identifier and the first harmonizing attribute can be the node portion of the first network identifier.

The various alternatives described above demonstrate the DSI component 204 providing for evaluating a matching condition by invoking a node match component 206 prior to generating and sending a match message 453 and/or by sending a match message including one or more first harmonizing attributes to a second NDS node 414. In some of alternatives, one or more second harmonizing attributes of a network interface of a node having a network identifier in a domain in the second domain space are not evaluated based on a matching condition in the second NDS node 414.

As described above, in some alternatives one or more second harmonizing attributes can be identified in a match response message 455. A DSI component 204 can be configured to receive a second harmonizing attribute identified in a match response message 455, and provide a corresponding first harmonizing attribute identified in a received query message 451 along with the received second harmonizing attribute to a node match component 206 to evaluate a matching condition based on the first and second harmonizing attributes provided by the DSI component 204 and received by the node match component 206.

As described, one or more additional and or alternative harmonizing attributes can be included in a query message 451, in a match message 453, and/or in a match response message 455 as described above. As described above evaluation in a matching condition can include one or more evaluations of one or more matching conditions. Evaluation can be performed by a node match component 206 in the geoNDS service 306 before and/or after communication with a NDS service representing a domain in a second domain space. Evaluation of at least a portion of the matching condition can be performed prior to receiving a query message 451 as described above. Evaluation of at least a portion of a matching condition can be performed by the geoNDS service 306 and/or by a service other than the geoNDS service 306, such as an NDS service representing a domain in a second domain space and hosted by another node, as illustrated by the second NDS node 414 in FIG. 4.

A node match component 206 in one or more of the NDS services representing the domains in the respective domain services can evaluate a matching condition based on the node portion of the first network identifier and a node portion of a second network identifier in a second domain space, and/or based on other harmonizing attributes of the first and second network identifiers. A node match component 206 in at least one of the NDS services can be configured to determine whether the node region 412 of the node identified by the second network identifier is at least partially included in the geospatial domain region 406. The node match components 206 can be the same component in the same NDS service and/or can be different node match components 206 in one or more of the NDS services. The matching condition based on the two harmonizing attributes and/or the matching condition based on the two regions can be determined prior to receiving the query including the first network identifier, prior to the sending of the match message 453, after sending the match message 453, and/or after receiving the match message response 455.

Returning to FIG. 1, in block 108 in response to determining a match based on the evaluation of the matching condition, a response to the query is sent including the second network identifier identifying the network interface of the node identified by the first network identifier and the first harmonizing attribute. Accordingly, a system for resolving a network identifier based on harmonized domain spaces includes means for, in response to determining a match based on the evaluation of the matching condition, sending a response to the query including the second network identifier identifying the network interface of the node identified by the first network identifier and the first harmonizing attribute. For example, as illustrated in FIG. 2, a response handler component 208 is configured to send a response to the query including at least one of the second network identifier identifying the network interface of the node identified by the first network identifier and the first harmonizing attribute, in response to determining a match based on the evaluation of the matching condition.

FIG. 2 illustrates a response handler component 208. The response handler component 208, as illustrated, is configured to send a response based determining a matched based on the evaluation of the matching condition. When a determination that the matching condition is met is made as provided for by the DSI component 204 as described above, (regardless of whether the determination is made at association setup or performed during the processing of a query message), a query response 457 can be generated. Generation of the query response message 457 can include operations by the query handler component 202 and/or the response handler component 208. The query response message 457 includes the second network identifier in a domain in the second domain space resolving the first network identifier in the first domain space to the second network identifier. The first and second network identifiers identify the same node that is in a domain in the first domain space and in a domain in the second domain spaces. One or more of the domains identifies a domain region 406 and the node 410 is associated with a node region 412 at least partially included in the domain region 406. The response can be formatted according to a publish-subscribe protocol, a presence protocol, a request-reply protocol, a store-and-forward protocol, and a DNS protocol.

In FIG. 3, the response handler component 208 illustrated sends the query response 457 by invoking a message-out handler component 312. The message-out handler component 312 can be configured to interface with and format the query response message 457 for sending by the network subsystem 304 to the network 408. The query response message 457 can be routed over the network 408 to the requesting node 404.

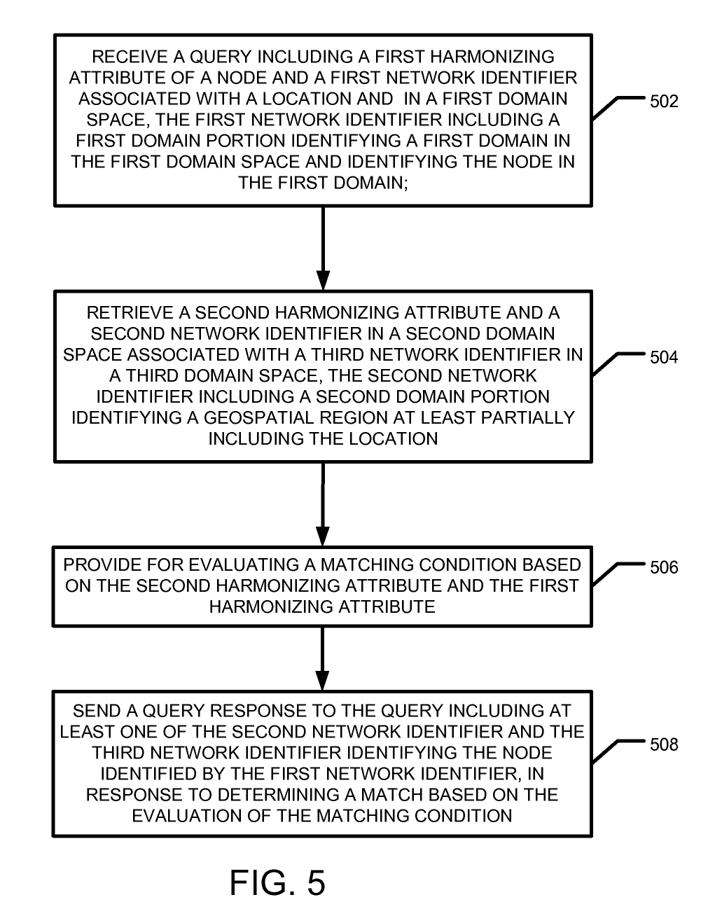

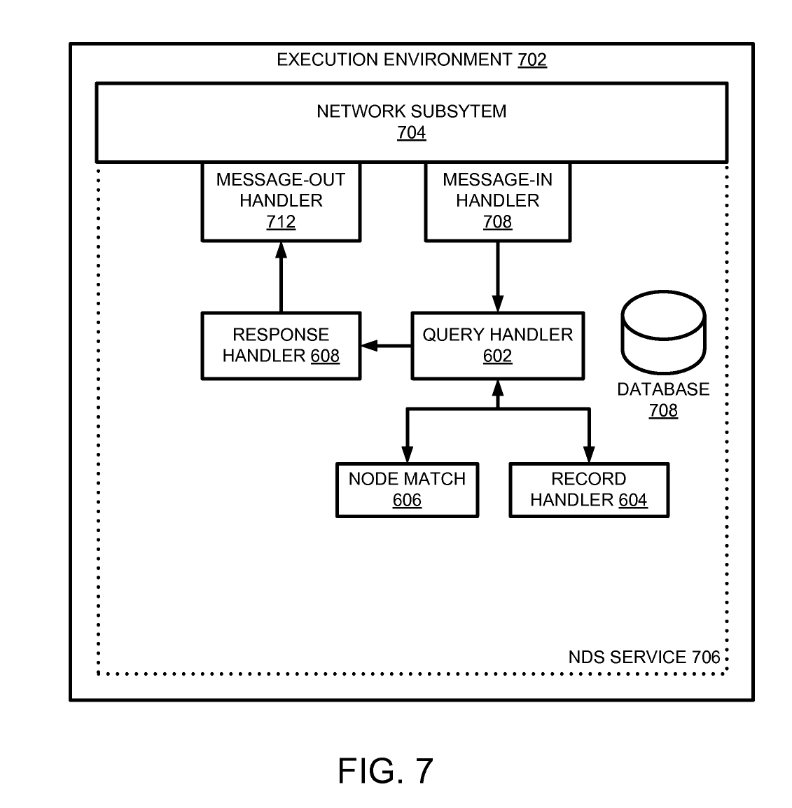

FIG. 5 is a flow diagram illustrating a method for resolving a network identifier based on harmonized domain spaces according to an exemplary aspect of the subject matter described herein. FIG. 6 is a block diagram illustrating an arrangement of components for resolving a network identifier based on harmonized domain spaces according to another exemplary aspect of the subject matter described herein. FIG. 7 is a block diagram illustrating an arrangement of components providing an execution environment configured to host the arrangement of components illustrated in FIG. 6. The method illustrated in FIG. 5 can be carried out by, for example, some or all of the components illustrated in FIG. 6 or their analogs operating in a compatible execution environment, such as the environment provided by some or all of the components illustrated in FIG. 7.

With reference to FIG. 5, in block 502 a query is received including a first harmonizing attribute and a first network identifier having a first domain portion identifying a domain in a first domain space. The first harmonizing attribute identifies a network interface of a node having a geospatial node region. The first network interface of the node is identified in the domain in the first domain space. Accordingly, a system for resolving a network identifier based on harmonized domain spaces includes means for receiving a query including a first harmonizing attribute and a first network identifier having a first domain portion identifying a domain in the a first domain space, the first harmonizing attribute identifying a network interface of a node having a geospatial node region and in the domain in the first domain space. For example, as illustrated in FIG. 6, a query handler component 602 is configured to receive a query including a first harmonizing attribute and a first network identifier having a first domain portion identifying a domain in the a first domain space, the first harmonizing attribute identifying a network interface of a node having a geospatial node region and in the domain in the first domain space. The first harmonizing attribute can be a node portion of the first network identifier.

The query received by the query handler component 602 includes a first network identifier in a domain in a first domain space. The first network identifier has a domain portion that identifies the domain in the first domain space. As described above, the identification can be direct and/or indirect through a relationship or association. The identification can further be explicit and/or implicit also as described above and below with respect to scoped addresses.

The query handler component 602 and other components illustrated in FIG. 6 can be adapted to operate in a number of execution environments, such as an execution environment 702 illustrated in FIG. 7. An exemplary execution environment is described above with respect to FIG. 3 and the arrangement of components illustrated in FIG. 2. The execution environment illustrated in FIG. 7 can be described analogously with respect to the arrangement of components in FIG. 6. The execution environment 702 includes any other components and/or subsystems required by a particular configuration of the components illustrated in FIG. 6 or their analogs. Such subsystems are common to computing devices such as desktop computers, servers, laptop computers, handheld computing devices, etc. For example, the execution environment 702 includes a network subsystem 704 configured to provide network communications in interoperation with at least some of the components operating in the execution environment 702. Execution environments can be provided by a node or a distributed execution environment can be provide by a collection of nodes.

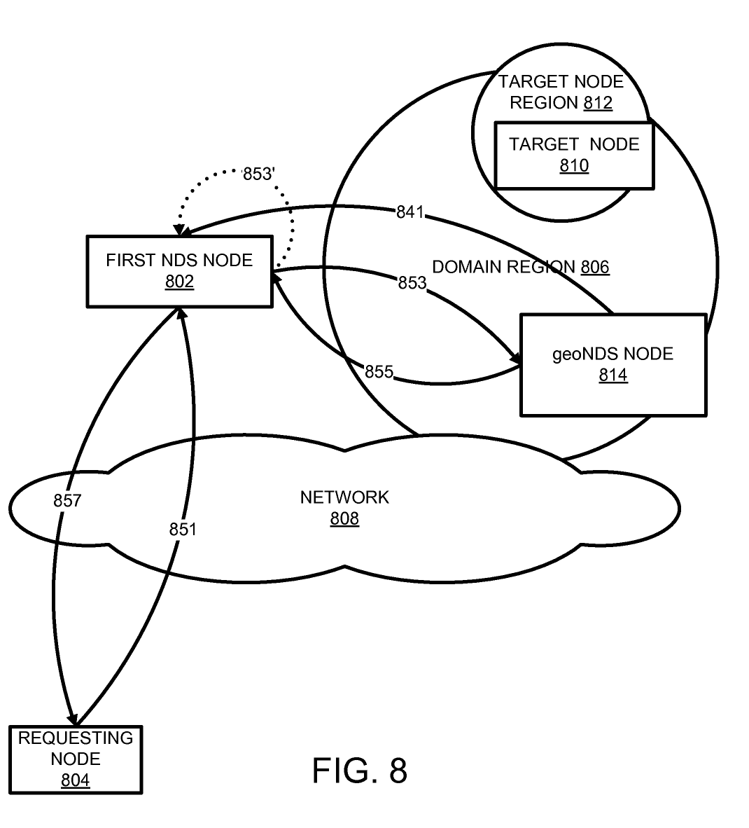

FIG. 8 illustrates a first NDS node 802 providing the execution environment 702 hosting the query handler component 602 included in a NDS service 706. The NDS service 706 represents a domain in a first domain space. The DNS is an examplary NDS as described above.

A NDS service 706 can be configured to maintain one or more associations between a node having network interface identified by a first network identifier from a domain represented by the service and a geospatial identifier of region associated with the node referred to as a node region as described above. As described above, the NDS service 706 can interoperate with a geoNDS including one or more geoNDS services hosted by one or more geoNDS nodes to maintain an association between a domain in a second domain space represented by the geoNDS and the first network identifier. The association can be based on the node region, associated with the first network identifier, at least partially including a domain region of a domain in the second domain space. See the description provided above concerning the sending of an update message 441 in FIG. 4. A NDS service 706 thus maintains an association between a second network identifier identifying a domain having a domain region in the second domain space and the first identifier in the domain in the first domain space. A NDS service 706 can be configured to maintain an association between the the represented domain in the first domain space and a network identifier in a domain having a domain region and in a second domain space where network identifier in the second domain space identifies a node have a node region at least partially included in the domain region. Note that the node region can be the domain region. Further a NDS service can be configured to maintain an association between at least one of a network identifier from the represented domain in the first domain space, geospatial and/or non-geospatial, and an identified domain from a second geospatial domain space. Associations can be stored in a memory, such as a database 708 as illustrated in FIG. 7.

The components of FIG. 6 are illustrated in FIG. 7 adapted for operation in the execution environment 702. The execution environment 702 can be provided by the NDS node 802 as described above. A requesting node 804 can be configured to send a query message 851 including a first network identifier in the form of a network address and/or in the form of a symbolic identifier of a network interface of a node in a first domain space analogous to the exemplary network identifiers described with respect to the query message 451 illustrated in FIG. 4. FIG. 8 illustrates the query message 851 can be received by the first NDS node 802 hosting the NDS service 706 representing a domain in the first domain space. The network interface of the node in the first domain space has a node region illustrated by a target node region 812 in FIG. 8.

As described above and below a network identifier explicitly and/or implicitly has and/or includes domain portion identifying a domain and a node portion identifying a node having a network interface in the identified domain. The node portion can be a harmonizing attribute as described in examplary alternatives below and analogous to those described above with respect to FIG. 1, FIG. 2, FIG. 3, and FIG. 4.

A query message 851 can include a harmonizing attribute as described above in addition and/or instead of a node portion of the network identifier in the query message 851. Also as described above with respect to FIG. 1, FIG. 2, FIG. 3, and FIG. 4, in various alternatives for performing the method depicted in FIG. 5, multiple harmonizing attributes can be included in a query message and a matching condition can be evaluated based on one or more harmonizing attributes included in a query message. For example, a node portion of a network identifier and an application identifier can be included in a query message. Alternatively, a query message can be sent including a domain portion of a network identifier and a harmonizing attribute, such as service identifier, where the messsage does not explicitly include a node portion of the network identifier.

As described above with respect to FIG. 1, FIG. 2, FIG. 3, and FIG. 4, a scoped identifier can be included in a query message and received by the query handler component 602 and processed according to the method depicted in FIG. 5 by some or all of the components illustrated in FIG. 6 operating in a compatible execution environment.

The query message 851 can be received by the query handler component 602 via a message-in handler component 710. The message handler component 710 can be configured to interoperate with the network subsystem 704 to listen for messages addressed to the first NDS service 706 operating in the execution environment 702 in the first NDS node 802. The network subsystem 704 can include a network stack, such as a TCP/IP network stack, including a network interface card (NIC), such as an Ethernet adapter, communicatively coupled to a network 808. The query message 851 can be sent by the requesting node 804 via the network 808 to the first NDS node 802 where it is received by the query handler component 602 as described.

The requesting node 804 can host an application including an identifier of a node such as a target node 810. The identifier can be a symbolic identifier. The application can be configured to establish communication via the network 808 with the target node 810. The requesting node 804 can be configured to determine a network address, such as a geospatial network address, of a network interface of the target node 810 based on the included symbolic identifier of the target node 810. The symbolic identifier included in the application can be a DNS name, a name from a geospatial domain space, a network address from a geospatial address domain space, or network address from a non-geospatial network address domain space.

In an example, the identifier is not usable as a network address for the network 808 and thus is a symbolic identifier to be resolved to a usable network address for communicating with the target node 810 via the network 808. The query message 851 can include, for example, a symbolic name of the target node 810 for determining a network address of the target node 810 on the network 808. The first network identifier, as a name or network address, of the target node 810 can be associated with the target node region 812, for example via a LOC record in the DNS as described above. The first network identifier the first domain space can be associated with a domain region 806 of a domain in a second domain space via the node region 812 of the first network identifier identifying a network interface of the target node 810. The association can be direct and/or indirect. The association between the first network identifier and the node region 812 can be maintained by the first NDS service 706 operating in the first NDS node 802. The queried network address, the second network identifier, is in a domain in a second domain space. For example, the second domain space can include network addresses, such as a geospatial portion of the IP address space and the domain can identify a subnet identifying a domain region. One or both of the first network identifier in the query message 851 and the queried second network identifier of the target node 810 can be a geospatial identifier, and/or can be associated with a geospatial identifier.

Alternatively and analogously, the application in the requesting node 804 can have a first network identifier and be configured to lookup a second network identifier from a second domain space of symbolic network identifiers. A query message 851 can be sent by a requesting node 804 to resolve a first network identifier to a second symbolic network identifier by performing the method illustrated in FIG. 1.

The message-in handler component 710 can be configured to route a received message based on an attribute of the message such as a message format and/or a command or other value included in the received message. The query handler component 602 in FIG. 7 can receive the query message information based on the received query message 851 from the message-in handler component 710 configured to route the query message information to the query handler component 602.

Returning to FIG. 5, in block 504 a second network identifier having a second harmonizing attribute is received. The second network identifier is in a domain, in a second domain space, having a geospatial domain region at least partially including the geospatial node region. Accordingly, a system for resolving a network identifier based on harmonized domain spaces includes means for receiving a second network identifier having a second harmonizing attribute and in a domain, in a second domain space, having a geospatial domain region at least partially at least partially including the geospatial node region. For example, as illustrated in FIG. 6, a record handler component 604 is configured to receive a second network identifier having a second harmonizing attribute and in a domain, in a second domain space, having a geospatial domain region at least partially at least partially including the geospatial node region. The second harmonizing attribute can be a target node portion of the second network identifier.

As described above, a node can be identified uniquely based on a geospatial identifier from a geospatial domain space. Each domain can be uniquely identified within the domain space and represented by one or more geoNDS services in a geoNDS representing the geospatial domain space. A first NDS service representing a domain in a first domain space can be configured to maintain an association between a first network identifier and a geospatial identifier in a domain in a second domain space. A geospatial identifier in an association maintained by a first NDS service can identify a node region at least partially included in a domain region of a domain in a second domain space represented by a second NDS service, such as a geoNDS service 814 illustrated in FIG. 8. A node region can be identified by an association between a network identifier and a geospatial identifier as in a LOC record in the DNS and/or can be identified in at least a portion of a network identifier. The received first network identifier can be a geospatial identifier identifying a node region and/or be associated with a geospatial identifier of a node region. An association between a network identifier in a domain in the first domain space and node region can be direct or indirect.

For example, a network interface of a node in a network can be assigned a network name from the geospatial domain space as the second domain space, such as 27639.main-st-123.cityhall. The network interface of the node can also be assigned a network address from the IPv4 network address space as the first domain space, such as 105.4.20.15. A location update message 841 can be sent from an NDS node, such as the geoNDS node 814B, representing the domain 27639 having a domain region 806 identified by the zip code to a NDS representing the first name space based on an association between the IPv4 network address and the geospatial network name maintained by the geoNDS node 814, The update message 841 can be routed in the NDS representing the first domain space to the first NDS node 802 representing the domain/subnet 105.4.20.0/255.255.255.0 for creating or updating a LOC record for the network interface of the node identified by the IPv4 network address.

An update message 841 can include additional information such as one or more harmonizing attributes, such as the node portion from the network name and/or the IP network address, as described in various alternatives below. The information can be received by the first NDS node 802 hosting the NDS service 706 representing the identified subnet of the IPv4 network address. The first NDS service 706 can be configured to update or create a record allowing the first NDS service 706 to communicate with and/or otherwise identify the geoNDS node 814 that originated the message 841 represents the NDS domain of the network interface of the target node 814 in the domain in the second domain space with a domain region 806 identified by the zip code 27639.

The first NDS service 706 can maintain records associating a network identifier in the represented domain in the first domain space with information identifying a node region for the network interface of the node identified by the network identifier. The association can be direct or indirect. An association can be stored in a single record or the association can be provided via multiple linked records. The network identifier has a node portion that can be a harmonizing attribute according to the configuration of the first NDS service 706 and the second NDS service representing the domain in the second domain space of the second identifier. Alternatively or additionally, one or more harmonizing attributes other than the node portion can be included in the association between the network identifier and the node region. The second domain space can include symbolic network identifiers of network interfaces and/or naming domains or and/or can include network addresses identifying network domains/subnets and network addresses of network interfaces of nodes.

The first NDS service 706 receiving the query message 851 can be configured to identify directly and/or indirectly a domain in a second domain space that includes a second network identifier in the second domain space identifying the network interface of a node identified by the received network identifier and harmonizing attribute. The DSI component 604 illustrated in FIG. 6 can be configured to receive a second network identifier having a second harmonizing attribute, such as a node portion of the second network identifier in a second domain. For example, the node portion “city-hall” in a geospatial second domain name space or “15” in the IPv4 network address domain space can be the second harmonizing attribute of received network identifiers “27639.main-st-123.city-hall” and “105.4.20.15”, respectively.

A match message 853 can be generated by the DSI component 604 or other component interoperating with the DSI component 604 in the first NDS service 706 based on the query message 851. For example, the match message 853 can include a harmonizing attribute received in the query message 851, such as a node portion of a first network identifier. Alternatively or additionally, the generated match message 853 can include the domain portion of the first network identifier identified in the query message 851. The match message additionally can include the geospatial identifier of associated node region. The match message 853 can be routed in the NDS representing the second domain space to a NDS node, the geoNDS node 814 as illustrated in FIG. 8, representing a domain having a domain region at least partially including the node region associated with the first identifier. In an aspect, the match message 853 can include an identifier of the domain region 806 and/or subregion at least partially including the node region in a first NDS node 802 configured to maintain an association between the domain of the first NDS node 802 and the domain region 806. The association can be direct or indirect. Alternatively, no information from the query message 851 can be included in the match message 853 for evaluating a matching condition by the geoNDS node 814. The first NDS service 706 can be configured to include information in the match message 853 according to a particular configuration for distributing the performing of the evaluation of a matching condition for generating a response to the query message 851. A matching condition can include one or more matching conditions that can be evaluated in one or more evaluation operations. In an alternative, the first NDS service 706 can provide information allowing all the matching to be performed external to the first NDS service 706. In another alternative, the first NDS service 706 can provide information allowing all the matching to be performed by the first NDS service 706. Various other alternatives include information in a matching message 853 to distribute the evaluation operation(s to various components within the first NDS service 706 and external to the first NDS service 706 operating in the first NDS node 802 and/or in other nodes.

The match message 853 is sent to an NDS service representing a domain in the second domain space, illustrated as the geoNDS node 814, identified by an association based on the first network identifier received in the query message 851. The match message 853 can be sent to a component within the execution environment 702 including a component of the first NDS service 706 representing the domain in the second domain space (illustrated by the dotted line message 853′). Alternatively, the DSI component 604 can send or provide for sending the match message 853 to the geoNDS node 814 representing a domain in the second domain.

The first NDS service 706 can maintain an association between the represented domain and an identifier of the domain in the second domain space indicating that a second network identifier in the domain in the second domain space has a node region at least partially included in the domain region 806 represented by the geoNDS node 814. The association can be maintained in a database 708. If more than one domain in a second domain space is identified in maintained associations, a match messages can be sent to NDS nodes each representing one or more of the domains in the second domain space(s). A receiving geoNDS node 814 can determine one or more network interfaces of nodes having network identifiers in the domain in the second domain space that have node regions that are at least partially included in the domain region 806. The determined one or more network identifiers along with corresponding harmonizing attributes for each one or more determined network interfaces can be included in a match response message 855 generated and sent by the geoNDS node 814 via the network 808. The match response message 855 can be received by the DSI component 604 via the network subsystem 704.

In another alternative a first NDS service 706 can maintain an association between the first network identifier and the domain/domain region 806, of a node having a network identifier in the domain in the second domain space. The association can be maintained in the database 708. The DSI component 604 can be configured to generate and send a match message 853 via the network subsystem 704 and the network 808 to a geoNDS node 814 representing a domain in a second domain space. A match message 853 can identify the domain/domain region 806 represented by the geoNDS node 814 eliminating a corresponding portion of the matching operation as opposed to the alternative described in the previous paragraph. The geoNDS node 814 can determine one or more network identifiers network interfaces of nodes, such as the target node 810, in the domain in the second domain space. The determined one or more network identifiers along with corresponding harmonizing attributes for each one or more determined network identifiers can be included in a match response message 855 generated and sent by the geoNDS node 814 via the network 808. A match response message 855 can be received by the DSI component 604 via the network subsystem 704.

In another alternative, the first NDS service 706 can maintain an association between the represented domain and a second harmonizing attribute of a network interface of a node having a network identifier in the domain in the second domain space and having a node region at least partially included in the domain region 806. The DSI component 604 can invoke an optional node match component 606 illustrated in FIG. 2 and illustrated in FIG. 7 configured to evaluate a matching condition based on the first harmonizing attribute and the second harmonizing attribute. If the condition is met, the DSI component 604 can be configured to generate and send a match message 853 to a geoNDS node 814 representing a domain in a second domain space. The match message 853 can identify the second harmonizing attribute and the domain region 806 to the geoNDS node 814. The geoNDS node 814 can determine one or more network identifiers having a matching harmonizing attribute and a node region at least partially included in the domain region. The determined one or more network identifiers along with any unevaluated corresponding harmonizing attributes for each one or more determined network identifiers can be included in a match response message 855 generated and sent by the geoNDS node 814 via the network 808. The match response message 855 can be received by the DSI component 604 via the network subsystem 704.

In yet another alternative, the first NDS service 706 can maintain an association between the represented domain, a second harmonizing attribute, and a domain region of a node having a network identifier in the domain in the second domain space. A node match component 606 invoked by the DSI component 604 can be configured to evaluate a matching condition based on the first harmonizing attribute and the second harmonizing attribute. The node match component 606 can be configured to determine NDS nodes representing a domain in a second domain space corresponding to a second harmonizing attribute producing a match in an evaluation of the matching condition based on the first and second harmonizing attributes. In response, the DSI component 604 can generate and send a match message 853 to the corresponding geoNDS node 814. The match message 853 can identify the second harmonizing attribute and be routed to the geoNDS node 814 based on the identified domain region 806. The geoNDS node 814 can determine one or more network identifiers having a matching harmonizing attribute based on a matching condition. The determined one or more network identifiers along with any unevaluated corresponding harmonizing attributes for each one or more determined network identifiers can be included in a match response message 855 generated and sent by the geoNDS node 814 via the network 808. The match response message 855 can be received by the DSI component 604 via the network subsystem 704.

The first NDS service 706, in a further alternative, can maintain an association between the represented domain and a network identifier from a domain in the second domain space, second harmonizing attribute, and a domain region at least partially included in the node region of the received first network identifier. A node match component 606 invoked by the DSI component 604 can be configured to evaluate a matching condition based on the first harmonizing attribute and the second harmonizing attribute to resolve the first network identifier to a second network identifier in a domain in a second domain space. A message 853 can include a call, an interprocess communication, and/or a sequence of executable machine code instructions (i.e. the message 853 can be implicit) from the DSI component 604 to the node match component 606 to perform the evaluation. The determined one or more nodes along with and unevaluated corresponding harmonizing attributes for each one or more determined network identifiers can be included in a match response message 855 generated and sent by the geoNDS node 814 via the network 808. The match response message 855 can be received by the DSI component 604 via the network subsystem 704.

The first NDS service 706 can maintain an association between the received first identifier and a network identifier in the domain in the second domain space. The association can be established based on previously matching a first harmonizing attribute and a second harmonizing attribute, and determining that the domain identified by the second network identifier has a domain region 806 at least partially including in the node region 812 of the first network identifier.

The various alternatives described above are not intended to be exhaustive as those skilled in the art will understand.

As described above, the geoNDS node 814 representing the domain in the second domain space can be configured to locate one or more network identifiers based on the information included in the match message. If no information is sent, the geoNDS node 814 can identify all network identifiers in the domain in the second domain space. If a node region is sent, the geoNDS node 814 can identify one or more network identifiers in the domain in the second domain space that have matching node regions. If all relevant first harmonizing attributes are included in the match message 853 and the domain region 806, subregion in the domain region 806, and/or location at least partially included in the domain region are also identified in the match message 853 the geoNDS node 814 can resolve the first network identifier to a second network identifier in the domain in the second domain space based on an evaluation of a matching condition including the first and second harmonizing attributes for a second network identifier of a network interface of a node having a node region at least partially included in the domain region 806 as determined based on the location information included in the match message 853

Returning to FIG. 5, in block 506 evaluating a matching condition is provided for. The matching condition is evaluated based on the second harmonizing attribute and the first harmonzing attribute. Accordingly, a system for resolving a network identifier based on harmonized domain spaces includes means for providing for evaluating a matching condition based on the second harmonizing attribute and the first harmonizing attribute. For example, as illustrated in FIG. 6, a node match component 606 is configured to provide for evaluating a matching condition based on the second harmonizing attribute and the first harmonizing attribute. The first harmonizing attribute can be the node portion of the second network identifier and the first harmonizing attribute can be the node portion of the first network identifier as described above.

The various alternatives described above demonstrate various configurations of a DSI component 604 providing for evaluating a matching condition by invoking a node match component 606 prior to generating and sending a match message 853 and/or by sending a match message including one or more harmonizing attributes to a geoNDS node 814. In some alternatives, one or more second harmonizing attributes of a network interface of a node having a network identifier in a domain in the second domain space are not evaluated based on a matching condition in the geoNDS node 814.

As described above, in some alternatives one or more second harmonizing attributes can be identified in a match response message 855. A DSI component 604.can be configured to receive a second harmonizing attribute identified in a match response message 855, and provide a corresponding first harmonizing attribute identified in a received query message 851 along with the received second harmonizing attribute to a node match component 606 to evaluate a matching condition based on the first and second harmonizing attributes provided by the DSI component 604 and received by the node match component 606.

As described, one or more additional and or alternative harmonizing attributes can be included in a query message 851, in a match message 853, and/or in a match response message 855 as described above. As described above evaluation in a matching condition can include one or more evaluations of one or more matching conditions. Evaluation can be performed by a node match component 606.in the first NDS service 706 before and/or after communication with a NDS service representing a domain in a second domain space. Evaluation of at least a portion of the matching condition can be performed prior to receiving a query message 851 as described above. Evaluation of at least a portion of a matching condition can be performed by the first NDS service 706 and/or by a service other than the first NDS service 706, such as an NDS service representing a domain in a second domain space and hosted by another node, as illustrated by the geoNDS node 814 in FIG. 8.

A node match component 606 in one or more of the NDS services representing the domains in the respective domain services can evaluate a matching condition based on the node portion of the first network identifier and a node portion of a second network identifier in a second domain space, and/or based on other harmonizing attributes of the first and second network identifiers. A node match component 606 in at least one of the NDS services can be configured to determine whether the node region 812 of the node identified by the second network identifier is at least partially included in the geospatial domain region 806. The node match components 606 can be the same component in the same NDS service and/or can be different node match components 606 in one or more of the NDS services. The matching condition based on the two harmonizing attributes and/or the matching condition based on the two regions can be determined prior to receiving the query including the first network identifier, prior to the sending of the match message 853, after sending the match message 853, and/or after receiving the match message response 855.

Returning to FIG. 5, in block 508, a response to the query is sent including the second network identifier identifying the network interface of the node identified by the first network identifier and the first harmonizing attribute. The response is sent in response to determining a match based on the evaluation of the matching condition Accordingly, a system for resolving a network identifier based on harmonized domain spaces includes means for sending a response to the query including the second network identifier identifying the network interface of the node identified by the first network identifier and the first harmonizing attribute, in response to determining a match based on the evaluation of the matching condition. For example, as illustrated in FIG. 6, a response handler component 608 is configured to send a query response to the query including the second network identifier identifying the network interface of the node identified by the first network identifier and the first harmonizing attribute, in response to determining a match based on the evaluation of the matching condition.

FIG. 6 illustrates a response handler component 608. The response handler component 608, as illustrated, is configured to send a response based determining a match based on the evaluation of the matching condition. When a determination that the matching condition is met is made as provided for by the DSI component 604 as described above, (regardless of whether the determination is made at association setup or performed during the processing of a query message), a query response 857 can be generated. Generation of the query response message 857 can include operations by the query handler component 602 and/or the response handler component 608. The query response message 857 includes the second network identifier in a domain in the second domain space resolving the first network identifier in the first domain space to the second network identifier. The first and second network identifiers identify the same node that is in a domain in the first domain space and in a domain in the second domain spaces. One or more of the domains identifies a domain region 806 and the node 810 is associated with a node region 812 at least partially included in the domain region 806.

In FIG. 7, the response handler component 608 illustrated sends the query response 857 by invoking a message-out handler component 712. The message-out handler component 712 can be configured to interface with and format the query response message 857 for sending by the network subsystem 704 to the network 808. The query response message 857 can be routed over the network 808 to the requesting node 804.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for resolving a network identifier based on harmonized domain spaces, the method comprising:
receiving a query including a first harmonizing attribute and a first network identifier having a first domain portion identifying a domain in a first domain space and identifying a geospatial domain region, the first harmonizing attribute identifying a network interface of the node in the domain in the first domain space;
retrieving a second network identifier having a second harmonizing attribute, the second network identifier in a domain in a second domain space and associated with a geospatial node region at least partially included in the geospatial domain region;
providing for evaluating a matching condition based on the second harmonizing attribute and the first harmonizing attribute; and
in response to determining a match based on the evaluation of the matching condition, sending a response to the query including the second network identifier identifying the network interface of the node identified by the first network identifier and the first harmonizing attribute,
wherein at least one of the preceding actions is performed on at least one electronic hardware component.

2. The method of claim 1 wherein each of the first harmonizing attribute and the second harmonizing attribute comprise data that is associated with a network identifier to match another network identifier.

3. The method of claim 2 wherein at least one of the first harmonizing attribute and the second harmonizing attribute includes at least one of a service type, a port number, an application identifier, an owner identifier, and a serial number.

4. The method of claim 1 wherein the first harmonizing attribute includes a requesting node portion identifying the node having the network interface in the domain in the first domain space.

5. The method of claim 1 wherein the first network identifier includes at least one of a network address and a symbolic identifier of the network interface.

6. The method of claim 1 wherein the second harmonizing attribute is a node portion of the second network identifier.

7. The method of claim 1 wherein the second domain space includes at least one network address and the domain in the second domain space identifies a subnet.

8. The method of claim 1 wherein the second network identifier includes at least one of a symbolic identifier and a portion of a network address wherein the at least one of the symbolic name and the portion of the network address identifies a node having a network interface in the domain in the second domain space.

9. The method of claim 1 further comprising resolving the first network identifier and the second network identifier to one another after a match has been determined.

10. The method of claim 1 wherein the first harmonizing portion comprises multiple harmonizing attributes and providing for the matching condition includes providing for a matching condition based on a plurality of the multiple harmonizing attributes.

11. The method of claim 1 wherein the query includes a scoped identifier.

12. The method of claim 1 wherein the first harmonizing attribute includes a node portion of the first network identifier and the second harmonizing attribute includes a node portion of the second network identifier, wherein providing for evaluating a matching condition based on the second harmonizing attribute and the first harmonizing attribute comprises providing for evaluating a matching condition based on the node portion of the second network identifier and the node portion of the first network identifier.

13. The method of claim 1 wherein determining the match condition comprises determining the match condition prior to receiving the query having the first network identifier.

14. The method of claim 1 wherein determining the matching condition comprises determining that the first network identifier and the second network identifier identify a same node that is in the domain in the first domain space and in the domain in the second domain space.

15. The method of claim 1 wherein at least one of the query and the response is formatted according to at least one of a publish-subscribe protocol, a presence protocol, a request-reply protocol, a store-and-forward protocol, and a DNS protocol.

16. A method for resolving a network identifier based on harmonized domain spaces, the method comprising:
receiving a query including a first harmonizing attribute and a first network identifier having a first domain portion identifying a domain in a first domain space, the first harmonizing attribute identifying a network interface of a node having a geospatial node region and in the domain in the first domain space;
retrieving a second network identifier having a second harmonizing attribute and in a domain, in a second domain space, having a geospatial domain region at least partially including the geospatial node region;
providing for evaluating a matching condition based on the second harmonizing attribute and the first harmonizing attribute; and
in response to determining a match based on the evaluation of the matching condition, sending a response to the query including the second network identifier identifying the network interface of the node identified by the first network identifier and the first harmonizing attribute,
wherein at least one of the preceding actions is performed on at least one electronic hardware component.

17. The method of claim 16 wherein each of the first harmonizing attribute and the second harmonizing attribute comprise data that is associated with a network identifier to match another network identifier.

18. The method of claim 16 wherein at least one of the first harmonizing attribute and the second harmonizing attribute includes at least one of a service type, a port number, an application identifier, an owner identifier, and a serial number.

19. The method of claim 16 wherein the first harmonizing attribute includes a requesting node portion identifying the node having the network interface in the domain in the first domain space.

20. The method of claim 16 wherein the first network identifier includes at least one of a network address and a symbolic identifier of the network interface.

21. The method of claim 16 wherein the second harmonizing attribute is a node portion of the second network identifier.

22. The method of claim 16 wherein the second domain space includes at least one network address identifier and the domain in the second domain space identifies a subnet.

23. The method of claim 16 wherein the second network identifier includes at least one of a symbolic identifier and a portion of a network address wherein the at least one of the symbolic identifier and the portion of the network address identifies a node having a network interface in the domain in the second domain space.

24. The method of claim 16 further comprising resolving the first network identifier and the second network identifier to one another after a match is determined.

25. The method of claim 16 wherein the first harmonizing attribute comprises multiple harmonizing attributes and providing for evaluating the matching condition comprises providing for evaluating the matching condition based on a plurality of the multiple harmonizing attributes.

26. The method of claim 16 wherein the query includes a scoped identifier.

27. The method of claim 16 wherein the first harmonizing attribute includes a node portion of the first network identifier and the second harmonizing attribute includes a node portion of the second network identifier and wherein providing for evaluating a matching condition based on the second harmonizing attribute and the first harmonizing attribute comprises providing for evaluating a matching condition based on the node portion of the second network identifier and the node portion of the first network identifier.

28. The method of claim 16 wherein determining the match condition comprises determining the match condition prior to receiving the query having the first network identifier.

29. The method of claim 16 wherein determining the matching condition comprises determining that the first harmonizing attribute and the second harmonizing attribute identify a same node that is in the domain in the first domain space and in the domain in the second domain space.

30. The method of claim 16 wherein at least one of the query and the response is formatted according to at least one of a publish-subscribe protocol, a presence protocol, a request-reply protocol, a store-and-forward protocol, and a DNS protocol.

31. A system for resolving a network identifier based on harmonized domain spaces, the system comprising:
means for receiving a query including a first harmonizing attribute and a first network identifier having a first domain portion identifying a domain in a first domain space and identifying a geospatial domain region, the first harmonizing attribute identifying a network interface of the node in the domain in the first domain space;
means for retrieving a second network identifier in domain in a second domain space and associated with a geospatial node region at least partially included in the geospatial domain region;
means for providing for determining a matching condition based on the second harmonizing attribute and the first harmonizing attribute; and
means for in response to determining a match based on the second harmonizing attribute and the first harmonizing attribute, sending a response to the query including the second network identifier identifying the network identified by the first network identifier and the first harmonizing attribute,
wherein at least one of the means includes at least one electronic hardware component.

32. A system for resolving a network identifier based on harmonized domain spaces, the system comprising system components including:
a query handler component configured to receive a query including a first harmonizing attribute and a first network identifier having a first domain portion identifying a domain in a first domain space and identifying a geospatial domain region, the first harmonizing attribute identifying a network interface of the node in the domain in the first domain space;
a domain space interface component configured to retrieve a second network identifier having a second harmonizing attribute, the second identifier in a domain in a second domain space and associated with a geospatial node region at least partially included in the geospatial domain region, the domain space interface component configured to provide for determining a matching condition based on the second harmonizing attribute and the first harmonizing attribute; and
a response handler component configured to send a response to the query including at the second network identifier identifying the network interface of the node identified by the first network identifier and the first harmonizing attribute in response to determining a match based on the evaluation of the matching condition,
wherein at least one of the system components includes at least one electronic hardware component.

33. A system for resolving a network identifier based on harmonized domain spaces, the system comprising:
means for receiving a query including a first harmonizing attribute and a first network identifier having a first domain portion identifying a domain in a first domain space, the first harmonizing attribute identifying a network interface of a node having a geospatial node region and in the domain in the first domain space;
means for retrieving a second network identifier having a second harmonizing attribute and in a domain in a second domain space, having a geospatial domain region at least partially including the geospatial node region;
means for providing for evaluating a matching condition based on the second harmonizing attribute and the first harmonizing attribute; and
means for, in response to determining a match based on the evaluation of the matching condition, sending a response to the query including the second network identifier identifying the network interface of the node identified by the first network identifier and the first harmonizing attribute,
wherein at least one of the means includes at least one electronic hardware component.

34. A system for resolving a network identifier based on harmonized domain spaces, the system comprising system components including:
a query handler component configured to receive a query including a first harmonizing attribute and a first network identifier having a first domain portion identifying a domain in a first domain space, the first harmonizing attribute identifying a network interface of a node having a geospatial node region and in the domain in the first domain space;
a record handler component configured to retrieve a second network identifier having a second harmonizing attribute and in a domain region at least partially including the geospatial node region;
a node match component configured to provide for determining a matching condition based on the second harmonizing attribute and the first harmonizing attribute; and
a response handler component configured to send a query response to the query in response to determining a match based on the evaluation of the matching condition, the query response including the second network identifier identifying the network interface of the node identified by the first network identifier and the first harmonizing attribute,
wherein at least one of the system components includes at least one electronic hardware component.

35. A computer readable medium embodying a computer program, executable by a machine, for resolving a network identifier based on harmonized domain spaces, the computer program comprising executable instructions for:
receiving a query including a first harmonizing attribute and a first network identifier having a first domain portion identifying a domain in a first domain space and identifying a geospatial domain region, the first harmonizing attribute identifying a network interface of a node in the domain in the first domain space;
retrieving a second network identifier having a second harmonzing attribute, the second network identifier in a domain in a second domain space and associated with a geospatial node region at least partially included in the geospatial domain region;
providing for determining a matching condition based on the second harmonizing attribute and the first harmonizing attribute; and
sending, in response to determining a match condition based on the evaluation of the matching condition, a response to the query including the second network identifier identifying the network interface of the node identified by the first network identifier and the first harmonizing attribute.

36. A computer readable medium embodying a computer program, executable by a machine, for resolving a network identifier based on harmonized domain spaces, the computer program comprising executable instructions for:
receiving a query including a first harmonizing attribute and a first network identifier having a first domain portion identifying a domain in the first domain, the first harmonizing attribute identifying a network interface of a node having a geospatial node region and in the domain in the first domain space;
retrieving a second network identifier having a second harmonizing attribute and in a domain, in a second domain space, having a geospatial domain region at least partially including the geospatial node region;
providing for determining a matching condition based on the second harmonizing attribute and the first harmonizing attribute;
sending, in response to determining a match based on the evaluation of the matching condition, a response to the query including the second network identifier identifying the network interface of the node identified by the first network identifier and the first harmonizing attribute.
